(19) United States
(12) Patent Application Publication
(10) Pub. No.: US 2024/0079714 A1
(43) Pub. Date: Mar. 7, 2024

(54) Thermal Runaway Prevention System

(71) Applicant: Southwest Research Institute, San Antonio, TX (US)

(72) Inventors: Christopher Hennessy, Helotes, TX (US); Ian Smith, San Antonio, TX (US)

(73) Assignee: Southwest Research Institute, San Antonio, TX (US)

(21) Appl. No.: 17/902,871

(22) Filed: Sep. 4, 2022

(51) Int. Cl. H01M 50/30; H01M 10/48; H01M 50/204; H01M 50/249; H01M 50/258; H01M 50/375

(52) U.S. Cl. CPC H01M 50/30; H01M 10/482; H01M 10/486; H01M 50/204; H01M 50/249; H01M 50/258; H01M 50/375; B60K 1/04; H01M 2200/00; H01M 2200/10; H01M 2200/20; H01M 2220/20

(57) ABSTRACT

A system for preventing thermal runaway among battery modules utilized to power equipment. The system may also be utilized to prevent thermal runaway within a battery module among battery cells on an intra-modular basis. The system is beneficial for equipment with an occupant space for accommodating an operator of the equipment. Thermal runaway may be avoided by the active use of a flow control device directed at a housing space containing a battery module that may be prone to failure. Specifically, air may be driven into the housing or drawn from the housing during the emergence of an unintended energy release from the battery module so as to prevent the thermal runaway. Further, directing the energy release away from the battery module includes routing the energy release away from other modules and the occupant space.

### BACKGROUND

Commercial, industrial and personal use vehicles and equipment are increasingly becoming more and more reliant on battery power for operation. Larger and more energy dense batteries are being developed to meet application needs, but this increase in pack size and energy density also increases the risk associated with managing a potential thermal runaway failure. This means that if battery failure in the form of thermal runaway occurs, a potentially deadly circumstance is presented. Unlike battery failure in a small electronic device where thermal runaway is unlikely and the user is not held in a confined moving space, battery failure that results in thermal runaway in a vehicle or manually operated equipment, can lead to severe injury or fatalities. Indeed, with the increased use of battery powered vehicles and manually operated equipment, thermal runaway related injury and death are also on the rise.

Lithium-ion batteries which are commonly utilized to power vehicles and manually operated equipment are particularly prone to thermal runaway. This occurs where a sealed battery cell of a module experiences overheating due to extreme use, defective manufacture or surrounding conditions. When this occurs, the sealed cell may break open or explode emitting hazardous gas and heat. This heat can lead to overheating of adjacent cells and further cell deterioration and so forth. Ultimately, a chain reaction resulting in a release of toxic gas into passenger areas, fire or even an explosion may occur. Given that these types of batteries are transported by air and other means and utilized in passenger vehicles and equipment, such occurrences can and do result in serious injury and fatalities.

Various efforts to minimize the likelihood of thermal runaway have been undertaken. The US Department of Transportation has established regulations regarding battery transport. Less reactive anode and cathode materials are utilized. Cobalt electrodes are generally avoided and less flammable electrolytes are utilized.

In addition to these measures, sensors may be utilized to detect pressure, heat or certain gasses that might be escaping. Generally, these sensors will be on the module level such that when a given cell of the module begins to raise pressure, heat or emit gas, the entire module will isolate. In theory, pressure, heat and gas emissions from a given cell may be vented by the isolating the module before other adjacent cells are affected or thermal runaway occurs.

Unfortunately, releasing hot gas as described may consist of releasing hot gas into a relatively confined space where other modules are likely present, either in use or in transport. The confined space not only includes these other modules that may still be affected by the hot gas release as described above, but the nature of the confined space itself may present an obstacle to attaining a true venting away of the hot gas from the source. Indeed, the likely confined nature of the space in combination with a relatively slow rate of hot gas dispersion means that hot gas may remain in the vicinity of vulnerable cells. One way or another, the likelihood of thermal runaway remains a considerable concern. Further, the confined space may also be close to or include passengers. Thus, venting of the hot gas may simply include exposure of heated toxins to passengers in an effort to prevent the thermal runaway from propagating, if not done in a controlled manner SUMMARY

A system for managing energy release from a cell of a battery module to prevent thermal runaway is disclosed. They system includes a housing for containing the module and a sensor of the housing to detect the energy release. An air inlet and an air outlet are coupled to the housing with a flow control device coupled to one of the inlet and the outlet. The flow control device is provided to actively manage the energy release detected by the sensor out of the housing in order to prevent the thermal runaway.

### BRIEF DESCRIPTION OF THE DRAWINGS

Implementations of various structure and techniques will hereafter be described with reference to the accompanying drawings. It should be understood, however, that these drawings are illustrative and not meant to limit the scope of claimed embodiments.

FIG. 1 is a schematic diagram of an embodiment of a thermal runaway prevention system.

FIG. 2 is perspective sectional view of the thermal runaway prevention system of FIG. 1 incorporated into a vehicle.

FIG. 3 is a chart summarizing emissions from a cell of a battery module of the thermal runaway prevention system of FIG. 1.

FIG. 4A is a schematic diagram of the thermal runaway prevention system of FIG. 1 during emissions from a battery module thereof.

FIG. 4B is a schematic diagram of the thermal runaway prevention system of FIG. 4A with a flow control device activated for management of the emissions from the battery module.

FIG. 5 is a flow-chart summarizing an embodiment of a method of employing a thermal runaway prevention system to avoid thermal runaway in a battery module.

### DETAILED DESCRIPTION

Embodiments are described with reference to a particular thermal runaway prevention system layout. Specifically, the embodiments depict a layout that includes a particular venting and flow control device arrangement as applied to a given battery module contained in housing. However, other layouts may be utilized. For example, a layout in which the flow control device is utilized to force air into the system when triggered to prevent thermal runaway is shown. However, the flow control device may be operated to instead draw air from the system when triggered to prevent thermal runaway. Regardless, so long as the layout includes a mode for actively forcing air through a housing containing the battery module when triggered to prevent thermal runaway, appreciable benefit may be realized. As used herein, the term “thermal runaway” may refer to thermal runaway on a battery module to battery module level or within a battery module on a battery cell to battery cell level (e.g. intra-module). Further, terms such as “preventing” or “avoiding” thermal runaway may refer to the halting of further or continued thermal runaway in circumstances where a degree of thermal runaway has occurred.

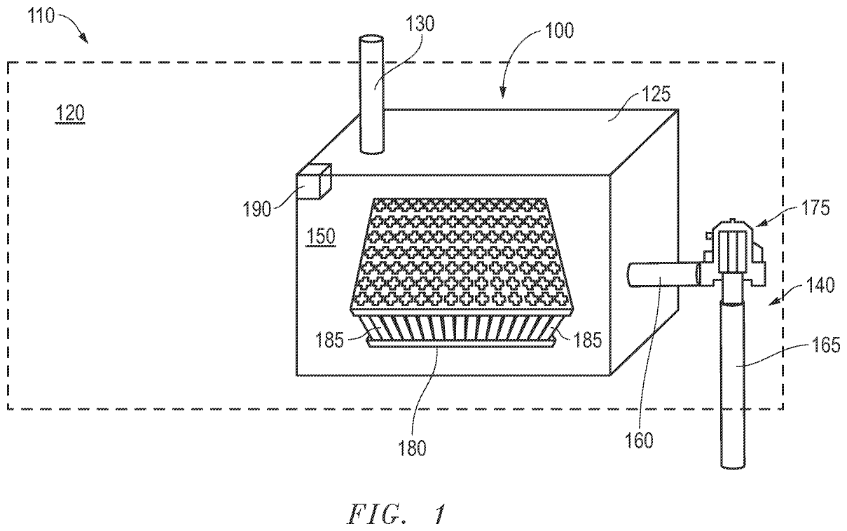

Referring now to FIG. 1, a schematic diagram of an embodiment of a thermal runaway prevention system 100 is shown. In this embodiment, the system 100 is found within a region 110 that includes a space 120 such as an occupant space for an operator of a vehicle that is configured to run on at least one battery module 180. The system 100 includes a housing 125 that isolates the module 180 from the remainder of the region 110, particularly the space 120 which may hold occupants. As with other manned vehicles and equipment, the battery 180 may be comprised of a number of cells 185 such as lithium ion cells.

Because battery cells 185 are subject to failure that may result in the release of energy in the form of gas or heat, the module 180 is kept isolated in a housing space 150 of the housing 125. As detailed further below, once an unintended energy release is detected by a sensor 190 of the housing 125, a flow control device 140 may be activated to prevent thermal runaway. That is, an active routed influx or removal of air from the housing space 150 may take place to prevent thermal runaway. In the case of a vehicle or equipment utilizing several battery modules 180 and systems 100, this means that adjacent modules 180 and systems 100 may be spared exposure to the energy release. Thus, thermal runaway to adjacent modules 180 and systems 100 may be avoided. In one embodiment, the sensor 190 is found at the module level and actually incorporated into module packaging. Thus, a plurality of sensors 190 may be found in each housing 125, all capable of relaying detections as described.

Furthermore, it is worth noting that even within the depicted module 180 there are a plurality of cells 185. Thus, where an energy release from one or more cells 185 is detected, the system 100 may actively react to not only prevent thermal runaway to adjacent modules 180 but may also react to prevent intra-module thermal runaway. That is, even on the individual module 180 level, the module 180 may be spared a thermal runaway in which an energy release might otherwise translate into a cell 185 to cell 185 to cell 185 thermal runaway.

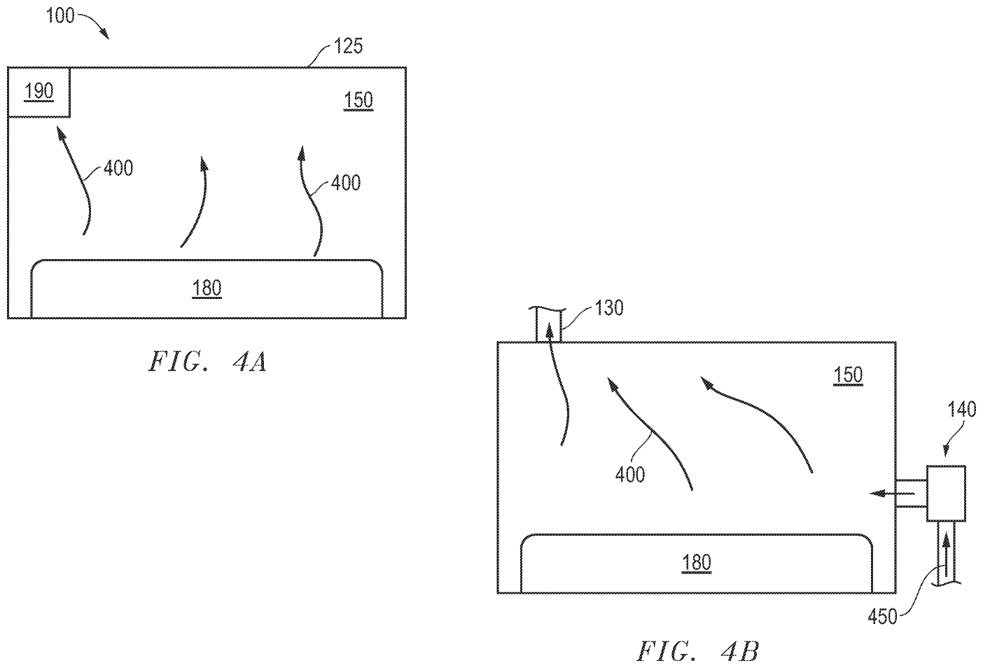

Continuing with reference to FIG. 1, the beginning of an energy release (as depicted in FIG. 4A) may be detected by a sensor 190 of the system housing 125. The sensor 190 may send a command signal to a controller of the flow control device 140. In one embodiment, the flow control device includes a compressor 175 to direct air from an external location and through an inlet 165 and channel 160 into the housing 125. Thus, a resultant pressure rise in the housing space 150 may force the energy release away from the system 100 (e.g. via an outlet 130). As a result, rather than a passive or uncontrolled energy release from one or more cells 185 of the module 180, a more active forcible drive of the energy release from the housing space 150 takes place at a time prior to a substantial accumulation of the energy release at the module 180. Therefore, the system 100 robs the module 180 of the opportunity to begin thermal runaway even on an intra-module level as noted above.

The sensor 190 may be one of a temperature or pressure sensor set to trigger the flow control device 140 based on a predetermined temperature or pressure level. Alternatively, or additionally, the sensor 190 may also be configured to detect presence of a gas such as carbon monoxide (CO), carbon dioxide (CO 2), a volatile organic compound (VOC) or hydrogen (H₂).

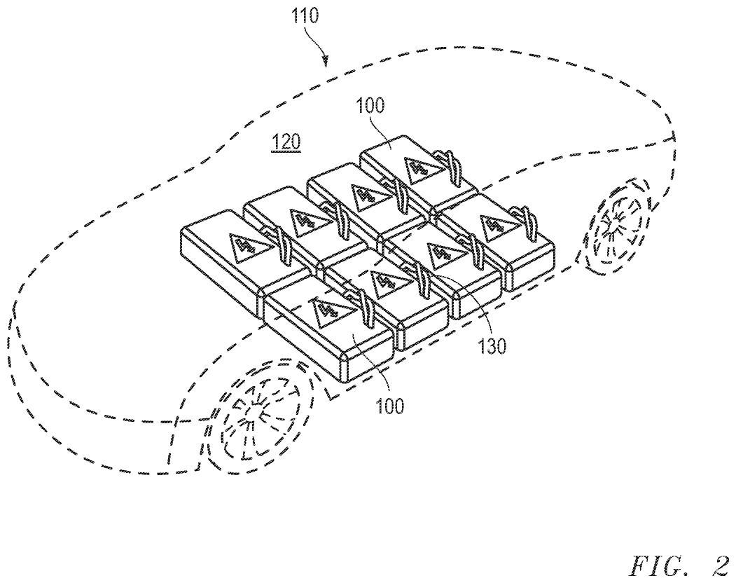

FIG. 2 is a perspective sectional view of the thermal runaway prevention system 100 of FIG. 1 incorporated into a vehicle 110. That is, the vehicle 110 is the region 110 of FIG. 1 which may include a passenger space 120. Therefore, in addition to avoiding thermal runaway for sake of preserving battery modules and ensuring vehicle safety, additional measures may be in order when dealing with the energy release itself.

Recall that the energy release described above may include toxic gases which may themselves be of extreme heat (e.g. perhaps in excess of 800° C.). Thus, embodiments of the system 100 are not only configured for actively directing the energy release away from the battery module 180 (see FIG. 1) as described above, but also for intentionally routing the energy release away from the vehicle 110 entirely via the outlet 130. As a result, any toxic gas or heat may be released as emissions away from the passenger space 120, similar to conventional emissions releases from internal combustion engine vehicles.

In the embodiment of FIG. 2, each battery module 180 of FIG. 1 is provided as part of a dedicated thermal runaway prevention system 100. Of course, there may be embodiments where each system 100 includes larger battery modules 180 than that illustrated in FIG. 1 or even multiple battery modules 180. Depending on vehicle power requirements, it is possible that all battery power may be supplied through a single thermal runaway prevention system 100 with one or more modules 180 therein. Alternatively, where the equipment or vehicle 110 utilizing the battery power is employed in a particularly hazardous environment such as for military or subsea vehicles or in dealing with hazardous waste, for example, each module 180 may be incorporated into a dedicated system 100 as illustrated in FIG. 1. Further, each module 180 may be of a predetermined limited number of cells 185. Thus, failure or underperformance of a sensor 190 or flow control device 140 at a given system 100, is less likely to translate into thermal runaway due to the backup presence of additional systems 100 with sensors 190 and flow control devices 140. Indeed, the overall number may be based on a variety of factors such as the layout of each system 100 and potential manifolding architecture that may be employed for interconnecting systems 100.

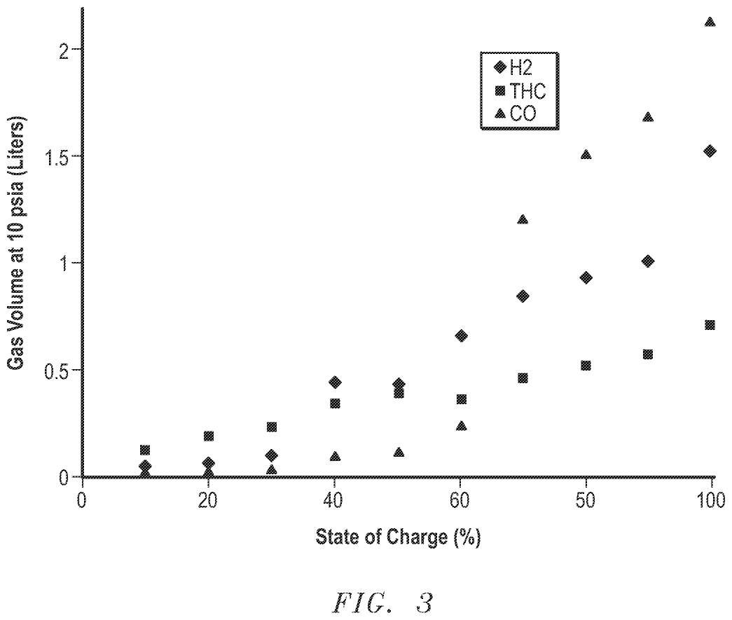

Referring now to FIG. 3, with added reference to FIG. 1, a chart summarizing emissions from a cell of a battery module 180 of the thermal runaway prevention system 100 is shown. More specifically, in a circumstance where a battery cell 185 substantially undergoes thermal runaway within a given system 100, the system 100 is configured to prevent continued thermal runaway or propagation to adjacent cells 185 and adjacent systems 100 (see also FIG. 2). The chart of FIG. 3 assumes a single LiCoO₂ 18650 cell 185. Of course, this is only exemplary.

For a modular battery 180 employing several thousand cells 185, upwards of 4.5 L of flammable toxic gas may be released for each cell 185 failure of the battery 180. The chart of FIG. 3 shows the volume of different toxic flammable gases that may be cumulatively emitted from a modular battery 180 as described depending on charge level. Of course, other gasses such as CO or HF may also be released. Thus, actively routing these types of emissions away from an area such as an occupant space 120 as shown in FIG. 2 may be of substantial benefit, even aside from the prevention of any thermal runaway progression to adjacent systems 100.

Referring now to FIG. 4A, a schematic diagram of the thermal runaway prevention system 100 of FIG. 1 is illustrated during emissions 400 from a battery module 180 thereof. The energy release 400 or emissions are depicted leaving the module 180 and beginning to occupy the housing space 150. As a result, pressure in the space 15 is increasing along with temperatures. Further, the emissions 400 may include a variety of different gaseous toxins as described above. The presence of one or more sensors 190 for detection of one or more of these emergent conditions means that the opportunity to signal a condition of concern before rupture of the housing 125 is available. In one embodiment, the housing 125 is thermal and pressure resistant and of durable construction with potential toxic exposure in mind. Thus, added time to effectively respond to the depicted energy release may be afforded.

Referring now to FIG. 4B, a schematic diagram of the thermal runaway prevention system 100 of FIG. 4A is illustrated with a flow control device 140 activated for management of the emissions 400 from the battery module 180. Specifically, with the housing 125 still in tact, the sensor 190 may signal the device 140 to drive external air 450 into the housing space 150, driving pressure further up and forcibly directing all air, including the emissions 400 of concern out through the outlet 130. The outlet 130 leads to an external location, for example, away from the occupant space 120 and entire vehicle 110 as illustrated in FIG. 2.

In one embodiment, the flow control device 140 is powered by the battery module 180 itself. However, more likely, the device 140 may be supplementally or alternatively powered by an independent low voltage, isolated power source to account for circumstances where the module 180 is insufficiently charged or compromised due to the illustrated process failure leading to the emissions 400. Further, the device 140 may be separately powered by the vehicle 110 or other equipment's own low-voltage system (e.g. such as a 12 or 24 V low-voltage system conventionally available in most passenger vehicles) (see FIG. 2).

The embodiment shown, illustrates the outlet 130 in a higher position than the flow control device 140. This may be of particular benefit for circumstances where the device 140 is a compressor configured to drive external air 450 into the housing space 150. Thus, hotter emissions 400 will naturally rise toward the elevated position of the outlet 130 as the cooler air 450 enters the space 150.

In another embodiment, the flow control device 140 may be provided in the form of a pump in place of a compressor. For such an embodiment, the device 140 may be located at the outlet 130 to aid in a suction or application of negative pressure in order to suck emissions 400 out of the housing space 150. For such an embodiment, the inlet 165 of FIG. 1 may connect directly to the housing 125 to responsively allow for the influx of outside air 450 to replace exiting emissions 400 and facilitate a continuous fluidic flow thereof out of the housing space 150. Regardless, the removal of the energy release 400 or emissions means that the system 100 may actively prevent thermal runaway to adjacent systems 100 or modules 180 (see FIGS. 1 and 2) and may even prevent intra-module runaway such that the depicted module 180 itself remains viable until replacement.

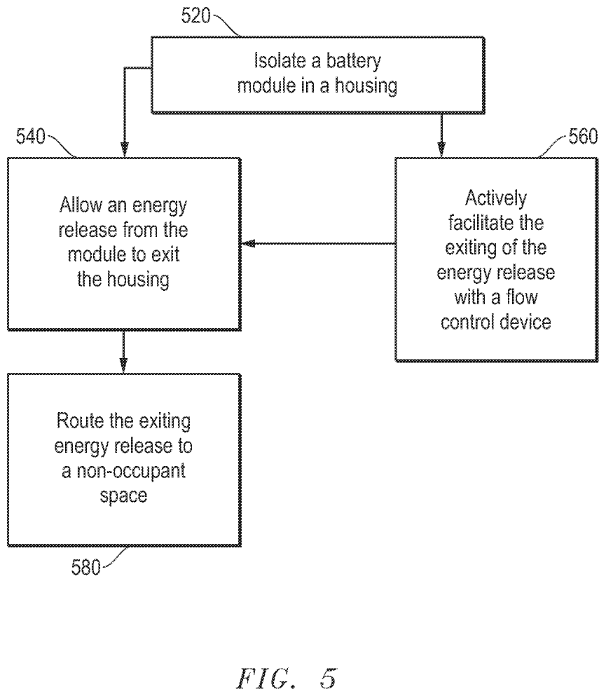

Referring now to FIG. 5, a flow-chart is shown summarizing an embodiment of a method of employing a thermal runaway prevention system to avoid thermal runaway in a battery module. The module is isolated in a housing of the system as indicated at 520. An energy release is allowed to exit the housing as noted at 540. As described above, this may be a release of emissions in the form of heat and various gasses from one or more cells of the module, depending on the types of cells utilized by the module.

As indicated at 560, the energy release from the housing is actively facilitated by the use of a flow control device such as a compressor or a pump. This is rendered possible by a sensor in the housing which is tailored to the types of cells utilized by the module. Upon detection of the energy release, the sensor may signal the flow control device to actively facilitate removal of the energy release from the housing of the system. Furthermore, as noted at 580, the removal of the energy release from the housing includes routing of emissions to a location away from any occupant space.

Embodiments described hereinabove include a system and techniques for preventing thermal runaway where batteries are utilized for powering vehicles and equipment. This is particularly beneficial for circumstances in which the vehicles or equipment are operated by an occupant. Specifically, embodiments of a thermal runaway prevention system allow for the continued use of battery modules in relatively confined areas that may include a plurality of other battery modules. Nevertheless, a conflagration of thermal runaway driven by the release of hot toxic gasses from one failing module may be avoided by the active driving out of hot toxic gasses from the module with a flow control device. Once more, the released heated toxic gasses are routed away from the vehicle or equipment to a non-occupant location.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. Furthermore, the foregoing description should not be read as pertaining only to the precise structures described and shown in the accompanying drawings, but rather should be read as consistent with and as support for the following claims, which are to have their fullest and fairest scope.

We claim:

1. A system for managing energy release from a cell of a battery module for preventing thermal runaway thereof, the system comprising:
a housing for containing the module;
a sensor of one of the housing and the module to detect the energy release;
an air inlet coupled to the housing;
an air outlet coupled to the housing; and
a flow control device coupled to at least one of the air inlet and the air outlet to actively manage the energy release detected by the sensor out of the housing for the preventing of the thermal runaway.

2. The system of claim 1 wherein the housing isolates the module from one of an occupant space of manned equipment powered by the module, another battery module and another system for managing energy release from the other module.

3. The system of claim 2 wherein the air outlet is configured to route the energy release to a location away from the one of the occupant space, the other battery module and the other system.

4. The system of claim 1 wherein the module is comprised of a plurality of lithium ion cells.

5. The system of claim 1 wherein the flow control device is one of a compressor and a pump.

6. The system of claim 5 wherein the compressor is coupled to the inlet.

7. The system of claim 5 wherein the pump is coupled to the outlet.

8. The system of claim 1 wherein the flow control device is powered by one of the module, a dedicated power source and a low voltage system of a vehicle powered by the module.

9. The system of claim 1 wherein the air outlet is coupled to the housing at a first location elevated above a second location whereat the air inlet is coupled to the housing.

10. The system of claim 1 wherein the sensor is one of a temperature sensor, a pressure sensor and a gas sensor.

11. Equipment comprising:
at least one battery module for powering the equipment;
an occupant space to accommodate an operator of the equipment;
a housing to isolate the battery module from the occupant space, one of the housing and the module further accommodating a sensor; and
a flow control device coupled to one of an air inlet of the housing and an air outlet of the housing for actively directing an energy release from the module detected by the sensor, the directing including forcing the energy release out of the housing through the air outlet.

12. The equipment of claim 11 wherein the equipment is a vehicle.

13. The equipment of claim 11 wherein the sensor is one of a temperature sensor, a pressure sensor and a gas sensor configured to detect the energy release as one of carbon monoxide, carbon dioxide, hydrogen and a volatile organic compound.

14. A method of preventing thermal runaway in battery powered equipment configured for accommodating an operator, the method comprising:
isolating a battery module in a housing;
detecting an unintentional energy release from the battery module;
actively directing the energy release out of the housing with a flow control device in response to the detecting of the release.

15. The method of claim 14 wherein the equipment includes an occupant space for the accommodating of the operator, the actively directing of the energy release further comprising routing the energy release away from the occupant space of the equipment.

16. The method of claim 15 wherein the equipment is a vehicle, the method further comprising operating the vehicle by an operator in the occupant space.

17. The method of claim 14 wherein the battery module is one of a plurality of battery modules for powering the equipment, the actively directing of the energy release out of the housing comprising preventing thermal runaway to another module of the plurality.

18. The method of claim 14 wherein the energy release from the module is an energy release from at least one battery cell of the module, the actively directing of the energy release out of the housing further comprising preventing thermal runaway by cells of the module on an intra-modular basis.

19. The method of claim 14 wherein the flow control device is a compressor, the actively directing of the energy release out of the housing comprising employing the compressor to increase pressure in the housing through an inlet to force the energy release out of the housing through an outlet.

20. The method of claim 14 wherein the flow control device is a pump, the actively directing of the energy release out of the housing comprising employing the pump to introduce a negative pressure at an outlet of the housing to draw the energy release therefrom.
